(19) United States
(12) Patent Application Publication
(10) Pub. No.: US 2005/0117691 A1
(43) Pub. Date: Jun. 2, 2005

(54) Method and apparatus for disposing of a fuel assembly channel of a boiling water reactor plant

(75) Inventor: Wolfgang Hummel, Weisendorf (DE)

Correspondence Address: LERNER AND GREENBERG, PA, P O BOX 2480, HOLLYWOOD, FL, 33022-2480, US

(73) Assignee: Framatome ANP GmbH

(21) Appl. No.: 10/984,601

(22) Filed: Nov. 9, 2004

Related U.S. Application Data
(63) Continuation of application No. PCT/EP03/05339, filed on May 22, 2003.

(30) Foreign Application Priority Data
Jun. 13, 2002 (DE) 102 26 245.4

(51) Int. Cl. G21C 17/00

(52) U.S. Cl. 376/434

(57) ABSTRACT

A method and a device for disposing of a fuel element case of a boiling water reactor installation include a support structure stabilizing the fuel element case. The case can, thus, be used as a transport container for additional appropriately conditioned parts that are to be disposed of, in particular, nuclear fittings by receiving therein such parts.

### CROSS-REFERENCE TO RELATED APPLICATION

This is a continuing application, under 35 U.S.C. § 120, of copending international application No. PCT/EP03/05339, filed May 22, 2003, which designated the United States; this application also claims the priority, under 35 U.S.C. § 119, of German patent application No. 102 26 245.4, filed Jun. 13, 2002; the prior applications are herewith incorporated by reference in their entirety.

### BACKGROUND OF THE INVENTION

1. Field of the Invention

The invention relates to a method for disposing of a fuel assembly channel or casing. The invention also relates to a method and an apparatus for disposing of radioactively contaminated parts of a boiling water reactor plant.

Internal components of a nuclear reactor plant that come into contact with the cooling water of the primary circuit are radioactively contaminated to a considerable extent and, if they were installed in the reactor core, are additionally activated. On account of operationally induced wear, which affects core internal components to a particularly high degree, it is necessary for these parts to be removed and replaced with new ones. The parts that have been removed have to be conditioned under strict safety conditions to make them suitable for disposal. Such a wearing part in a boiling water reactor is also the fuel assembly channel, which has been embrittled as a result of high levels of radiation, of a spent fuel assembly, as illustrated in a plan view of the bottom side and of one of the longitudinal sides in FIGS. 1A and 1B, respectively, for example. The wall 2 of such a fuel assembly channel 4 surrounds a substantially cuboidal cavity 6. The fuel assembly channel 4 is open at its end sides and is provided with supporting struts 8a at opposite corners of just one end side, which struts are used to secure the fuel assembly channel 4 to a non-illustrated fuel assembly top fitting. Furthermore, in its lower region, the fuel assembly channel 4 is provided with further elements, in the present example, lugs 8b and external plates 8c, which are specific to the type of channel illustrated in the example. During conditioning of such a fuel assembly channel, the channel is generally compressed and, then, cut into small pieces. However, such a procedure is complex.

### SUMMARY OF THE INVENTION

It is accordingly an object of the invention to provide a method and apparatus for disposing of a fuel assembly channel of a boiling water reactor plant that overcome the hereinafore-mentioned disadvantages of the heretofore-known devices and methods of this general type and that represents a simplification compared to the procedure described in the prior art and that enables disposal of radioactively contaminated parts of a boiling water reactor plant.

With the foregoing and other objects in view, there is provided, in accordance with the invention, a method for disposing of a hollow fuel assembly channel of a fuel assembly of a boiling water reactor plant, including the steps of providing the hollow fuel assembly channel that is to be disposed and stabilizing the fuel assembly channel with a support structure.

According to the invention, the fuel assembly channel is stabilized using a support structure. In other words, the fuel assembly channel is not destroyed, but, rather, is provided with one or more components that support it and impart a greater strength or stability to it. This means that complex pressing and destruction of the fuel assembly channel is no longer required, which simplifies its disposal. A fuel assembly channel that has been so conditioned or prepared for disposal may, moreover, serve simultaneously as a transport container for further parts that are to be disposed of and have been conditioned accordingly, in particular, for core internal parts or for small-volume core scrap.

With the objects of the invention in view, there is also provided a method for disposing of a hollow fuel assembly channel of a fuel assembly of a boiling water reactor plant, including the step of stabilizing the hollow fuel assembly channel that is to be disposed with a support structure.

With the objects of the invention in view, there is also provided a method for disposing of radioactively contaminated parts of a boiling water reactor plant, including the steps of providing a radioactively contaminated, hollow fuel assembly channel that is to be disposed, stabilizing the fuel assembly channel with a support structure, and utilizing the support structure as transport container for the fuel assembly channel.

With the objects of the invention in view, there is also provided a method of disposing radioactively contaminated parts of a boiling water reactor plant, including the steps of stabilizing a radioactively contaminated, hollow fuel assembly channel that is to be disposed with a support structure and transporting the fuel assembly channel with the support structure as a transport container for the fuel assembly channel.

In accordance with another mode of the invention, the fuel assembly channel is provided with a carry handle. The handle allows it to be handled in the same way and using the same devices as provided for the handling of the fuel assembly.

In accordance with a further mode of the invention, the support structure is pre-assembled and introduced into the fuel assembly channel. Such a configuration considerably shortens the processing time required at the fuel assembly channel to fit the support structure.

In particular, the fuel assembly channel is closed off on one of its end sides with the aid of a base plate that is disposed on the support structure and serves as a base. As such, it can be used as a container for holding small-volume core scrap.

With regard to the method according to the invention, because the stabilized fuel assembly channel is used as transport container for further radioactively contaminated parts, it can be disposed of at particularly low cost together with the core scrap.

In accordance with an added mode of the invention, the support structure is provided with a base plate forming a base of the support structure and the closing step is carried out by closing off the one side with the base plate.

In accordance with an additional mode of the invention, the leaves are separated from a control element that is to be disposed of and are introduced into the stabilized fuel assembly channel. Because the longitudinal and transverse dimensions of the leaves of a control element may correspond substantially to those of a fuel assembly channel, these leaves can be accommodated in a fuel assembly channel in an extremely space-saving form, which channel is capable of accommodating the leaves of three control elements.

In particular, the support structure uses an internal partition to divide the fuel assembly channel into at least two subregions that are supported when the leaves are being introduced into one of the subregions. This facilitates filling of the fuel assembly channel.

In accordance with yet another mode of the invention, the stabilizing step is carried out by inserting the support structure inside the hollow fuel assembly channel.

In accordance with yet a further mode of the invention, there are provided the steps of dividing the stabilized fuel assembly channel into at least two subregions with an internal partition of the support structure and supporting the leaves in the subregions when the leaves are introduced therein.

In accordance with yet an added mode of the invention, there are provided the steps of separating control rod leaves that are to be disposed from a control rod and introducing the separated control rod leaves into the stabilized fuel assembly channel.

With the objects of the invention in view, there is also provided an apparatus for disposing of radioactively contaminated parts of a boiling water reactor plant, including a transport container having a support structure, the support structure shaped to stabilize a radioactively contaminated fuel assembly channel that is to be disposed.

In accordance with yet an additional feature of the invention, the support structure has a carrying handle for transporting the transport container.

In accordance with again another feature of the invention, the fuel assembly channel has a side and an opening on the side and the support structure has a base plate shaped to close off the opening on the side of the fuel assembly channel.

In accordance with again a further feature of the invention, the fuel assembly channel has an interior and the support structure divides the interior of the fuel assembly channel into at least two subregions when the support structure is disposed in the fuel assembly channel and has at least one partition plate disposed on the base plate and perpendicular to the base plate.

With the objects of the invention in view, there is also provided an apparatus for disposing of a radioactively contaminated fuel assembly channel of a boiling water reactor plant, the assembly channel having a side, an opening on the side, and an interior, the apparatus including a transport container having shape sized to fit in the interior of the fuel assembly channel to be disposed and configured to stabilize structurally the fuel assembly channel and a support structure having a carrying handle for transporting the transport container and a base plate shaped to close off the opening on the side of the fuel assembly channel.

Other features that are considered as characteristic for the invention are set forth in the appended claims.

Although the invention is illustrated and described herein as embodied in a method and apparatus for disposing of a fuel assembly channel of a boiling water reactor plant, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1A is a plan view of a prior art fuel assembly channel as viewed from the right end of FIG. 1B;

FIG. 1B is a fragmentary, side elevational view of the fuel assembly channel of FIG. 1A;

FIG. 2A is a plan view of a support structure according to the invention as viewed from the right end of FIG. 2B;

FIG. 2B is a fragmentary, side elevational view of the support structure of FIG. 2A;

FIG. 3A is a plan view of a fuel assembly channel according to FIGS. 1A and 1B that has been stabilized with the support structure of FIGS. 2A and 2B as viewed from the right end of FIG. 3B;

FIG. 3B is a fragmentary, side elevational view of the stabilized fuel assembly channel of FIG. 3A;

FIG. 4A a plan view of the stabilized fuel assembly channel of FIGS. 3A and 3B as viewed from the right end of FIG. 4B and is filled with leaves of control rods; and

FIG. 4B is a fragmentary, side elevation view of the stabilized fuel assembly channel of FIG. 4A filled with the leaves of the control rods.

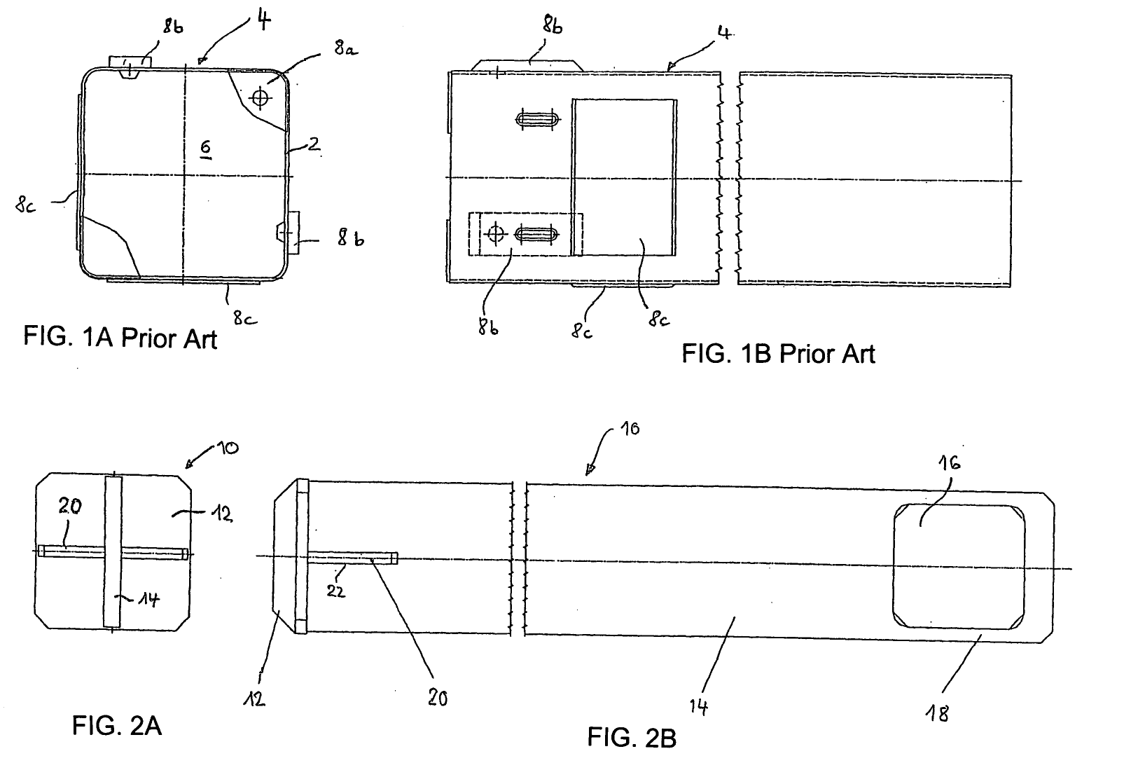

### DESCRIPTION OF THE PREFERRED EMBODIMENTS

Referring now to the figures of the drawings in detail and first, particularly to FIGS. 2A and 2B thereof, there is shown a support structure 10 having a base plate 12 that bears a partition plate 14 running perpendicular to the flat side of the base plate 12 and, in particular, is welded to the partition plate 14. The longitudinal extent of the partition plate 14 is greater than the longitudinal extent of the fuel assembly channel 4 and, at its free end that is remote from the base plate 12, the partition plate 14 is provided with a recess 16 that forms a carry handle 18. A spacer plate 20 is secured to the base plate 12, transversely with respect to the partition plate 14 and perpendicular to the base plate 12, passing through the partition plate 14, which is provided with a slot 22 in this region.

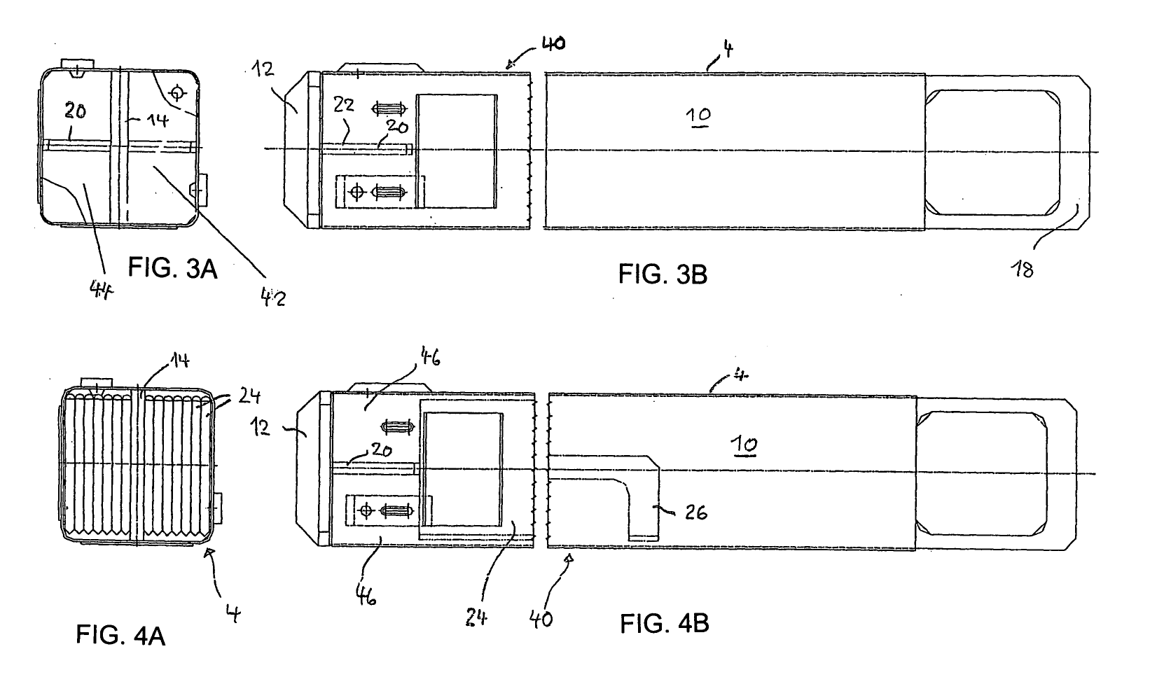

FIGS. 3A and 3B show the fuel assembly channel 40 that has been stabilized using the support structure 10. For such a purpose, the support structure has been introduced into the empty fuel assembly channel 4 from the base side until the base plate 12 closes off the empty fuel assembly channel 4 and forms a base. The carrying handle 18, then, projects beyond the fuel assembly channel 4. It can also be seen from FIGS. 3A and 3B that the fuel assembly channel 4 is divided into two subregions 42, 44 by the partition plate 14.

In accordance with FIGS. 4A and 4B, control rod leaves 24, which, in a previous working step, have been separated from control rods that are to be disposed of and of which an arch 26 of another carrying handle 18, which has been halved by previous dismantling and is shown in FIG. 4b, have been introduced into the fuel assembly channel 40 that has been stabilized using the support structure 10.

The spacer plate 20 serves to support the control rod leaves 24 so that the space used to accommodate the control rod leaves 24 remains free of disruptive internals located in the lower region of the fuel assembly channel 4. At the same time, four subchambers 46, which can be used to accommodate small-volume core scrap, are formed beneath the control rod leaves 24.

1. A method for disposing of a hollow fuel assembly channel of a fuel assembly of a boiling water reactor plant, which comprises:
providing the hollow fuel assembly channel that is to be disposed; and
stabilizing the fuel assembly channel with a support structure.

2. The method according to claim 1, which further comprises providing the support structure with a carrying handle.

3. The method according to claim 1, which further comprises prefabricating the support structure and introducing the support structure into the fuel assembly channel.

4. The method according to claim 1, which further comprises closing off one of two end sides of the fuel assembly channel.

5. The method according to claim 1, which further comprises closing off one of two end sides of the fuel assembly channel with the support structure.

6. The method according to claim 3, which further comprises closing off one of two end sides of the fuel assembly channel with the support structure.

7. The method according to claim 4, which further comprises:
providing the support structure with a base plate forming a base of the support structure; and
carrying out the closing step by closing off the one side with the base plate.

8. The method according to claim 5, which further comprises:
providing the support structure with a base plate forming a base of the support structure; and
carrying out the closing step by closing off the one side with the base plate.

9. The method according to claim 6, which further comprises:
providing the support structure with a base plate forming a base of the support structure; and
carrying out the closing step by closing off the one side with the base plate.

10. The method according to claim 1, which further comprises carrying out the stabilizing step by inserting the support structure inside the hollow fuel assembly channel.

11. A method for disposing of a hollow fuel assembly channel of a fuel assembly of a boiling water reactor plant, which comprises:
stabilizing the hollow fuel assembly channel that is to be disposed with a support structure.

12. A method for disposing of radioactively contaminated parts of a boiling water reactor plant, which comprises:
providing a radioactively contaminated, hollow fuel assembly channel that is to be disposed;
stabilizing the fuel assembly channel with a support structure; and
utilizing the support structure as transport container for the fuel assembly channel.

13. The method according to claim 12, which further comprises:
separating control rod leaves that are to be disposed from a control rod; and
introducing the separated control rod leaves into the stabilized fuel assembly channel.

14. The method according to claim 13, which further comprises dividing the stabilized fuel assembly channel into at least two subregions with an internal partition of the support structure, the subregions being supported when the leaves are being introduced into one of the subregions.

15. The method according to claim 13, which further comprises:
dividing the stabilized fuel assembly channel into at least two subregions with an internal partition of the support structure; and
supporting the leaves in the subregions when the leaves are introduced therein.

16. A method of disposing radioactively contaminated parts of a boiling water reactor plant, which comprises:
stabilizing a radioactively contaminated, hollow fuel assembly channel that is to be disposed with a support structure; and
transporting the fuel assembly channel with the support structure as a transport container for the fuel assembly channel.

17. The method according to claim 16, which further comprises:
separating control rod leaves that are to be disposed from a control rod; and
introducing the separated control rod leaves into the stabilized fuel assembly channel.

18. The method according to claim 17, which further comprises dividing the stabilized fuel assembly channel into at least two subregions with an internal partition of the support structure, the subregions being supported when the leaves are being introduced into one of the subregions.

19. The method according to claim 17, which further comprises:
dividing the stabilized fuel assembly channel into at least two subregions with an internal partition of the support structure; and
supporting the leaves in the subregions when the leaves are introduced therein.

20. An apparatus for disposing of radioactively contaminated parts of a boiling water reactor plant, comprising:
a transport container having a support structure, said support structure shaped to stabilize a radioactively contaminated fuel assembly channel that is to be disposed.

21. The apparatus according to claim 20, wherein said support structure has a carrying handle for transporting said transport container.

22. The apparatus according to claim 20, wherein:
the fuel assembly channel has a side and a opening on the side; and
said support structure has a base plate shaped to close off the opening on the side of the fuel assembly channel.

23. The apparatus according to claim 22, wherein:
the fuel assembly channel has an interior; and
said support structure:
divides the interior of the fuel assembly channel into at least two subregions when said support structure is disposed in the fuel assembly channel; and
has at least one partition plate disposed on said base plate and perpendicular to said base plate.

24. An apparatus for disposing of a radioactively contaminated fuel assembly channel of a boiling water reactor plant, the assembly channel having a side, an opening on the side, and an interior, the apparatus comprising:
a transport container having:
a shape sized to fit in the interior of the fuel assembly channel to be disposed and configured to stabilize structurally the fuel assembly channel; and
a support structure having:
a carrying handle for transporting said transport container; and
a base plate shaped to close off the opening on the side of the fuel assembly channel.

25. The apparatus according to claim 24, wherein said support structure:
divides the interior of the fuel assembly channel into at least two subregions when said support structure is disposed in the fuel assembly channel; and
has at least one partition plate disposed on said base plate and perpendicular to said base plate.

26. The method according to claim 12, wherein the contaminated parts are core internal components.

27. The method according to claim 16, wherein the contaminated parts are core internal components.

28. The apparatus according to claim 20, wherein the contaminated parts are core internal components.

29. The apparatus according to claim 24, wherein the contaminated parts are core internal components.
